(19) United States
(12) Patent Application Publication
(10) Pub. No.: US 2007/0211176 A1
(43) Pub. Date: Sep. 13, 2007

(54) Apparatus and method for adjusting saturation image

(75) Inventors: Kai-Hsiang Hsu, Tucheng City (TW); Yi-Chia Shan, Jhongli City (TW); Tsan-Hung Tsai, Sanchong City (TW); Hsu-Pin Kao, Pingihen City (TW); Hsu-Chia Kao, Pingihen City (TW)

Correspondence Address: BIRCH STEWART KOLASCH & BIRCH, PO BOX 747, FALLS CHURCH, VA, 22040-0747, US

(73) Assignee: MARKETECH INTERNATION CORP.

(21) Appl. No.: 11/493,759

(22) Filed: Jul. 27, 2006

(30) Foreign Application Priority Data
Mar. 8, 2006 (TW) 095107695

(51) Int. Cl. H04N 9/68; H04N 9/64

(52) U.S. Cl. 348/645; 348/649

(57) ABSTRACT

A method for adjusting a degree of saturation of a target pixel is provided. In a first color space, the target pixel is represented by a brightness factor and a set of color factors. Based on the set of color factors, the method first generates an original saturation and a hue factor. Then, selectively according to the brightness factor, the hue factor, and the original saturation, an adjusting gain is generated. The method, according to this invention, multiplies the original saturation by the adjusting gain to generate a new saturation for the target pixel.

### BACKGROUND OF THE INVENTION

1. Field of the Invention

The present invention relates to image processing methods and apparatuses and, more specifically, to methods and apparatuses for adjusting saturation degrees of images.

2. Description of the Prior Art

Typically, when adjusting colors of a colored image, users must first transform the image from an RGB color space into a color space with separate brightness and color factors (for instance, YUV, YIQ, YCbCr, or CIELab color spaces). Subsequently, color factors of the image are processed. Taking CIELab (also called Lab) color space as an example, every color in Lab color space has a unique set of coordinates (L,a,b), wherein L is the brightness factor of the color, and a and b are color factors of the color. If a and b are both zero, different L can represent white colors with various brightness. If the value of L is constant, different (a, b) represent various colors with the same brightness. As known by those skilled in this art, the saturation degree of a color can be represented by (a²+b²)^{0.5}. With the same brightness, the colors located closer to the origin of the (a, b) plane are lighter and have lower saturation degrees. On the contrary, the colors located farther to the origin are thicker and have higher saturation degrees. Besides, the hue of a color can be represented as tan⁻¹(b/a). Different hue corresponds to colors with different attributes.

As mentioned above, in a color space with separate brightness and color factors, the saturation degree (S) and hue (H) of one color can be defined by the two color factors, (a, b). In traditional methods for adjusting saturation degrees, the original saturation degrees of pixels in an image are first generated by calculating the color factors (a, b) of the pixels. Then, the original saturation degrees are analyzed for further adjusting the saturation degree of the image.

Actually, human beings have different sensitivities to various hues. When the saturation degree of an image changes, viewers will have stronger perceptions for colors with hue to which they are more sensitive. Alternatively, some viewers may expect these colors with hue, to which they are more sensitive, to have higher saturation degrees. Furthermore, brightness (L) also affects the judgment of saturation degrees for viewers. Human eyes distinguish fewer colors and have weaker perceptions for saturation degrees at higher and lower brightness.

Accordingly, if users adjust the saturation degree of an image only based on its original saturation degree without considering other factors such as hue and brightness, the adjusted image inevitably will not be the best result.

### SUMMARY OF THE INVENTION

To solve the aforementioned problem, the present invention provides methods and apparatuses for adjusting the saturation degree of an image. The methods and apparatuses, according to this invention, adjust the saturation degree of an image based on the original saturation degree, hue, and brightness of the image simultaneously, instead of only considering the original saturation degree. Therefore, the present invention can provide adjusted images more conforming to visual characteristics of human beings.

In the present invention, the target pixel is hypothetically set to be represented as a brightness factor and a set of color factors in a first color space. One preferred embodiment, according to this invention, is an image adjusting method. In this method, an original saturation degree and a hue factor are first generated according to the set of color factors. Next, an adjusting gain is generated selectively according to the brightness factor, the hue factor, and the original saturation degree. According to this invention, multiplying the original saturation degree by the adjusting gain can subsequently generate a new saturation degree for the target pixel.

The other preferred embodiment, according to this invention, is an image adjusting apparatus. This apparatus includes a calculating module, a generating module, and a multiplying module. The calculating module is used for generating an original saturation degree and a hue factor according to the set of color factors. The generating module is used for generating an adjusting gain selectively according to the brightness factor, the hue factor, and the original saturation degree. The multiplying module is used for multiplying the original saturation degree by the adjusting gain to generate a new saturation degree for the target pixel.

The methods and apparatuses, according to this invention, can be applied in every color space with separate brightness and color factors, such as YCbCr, YUV, Lab, HIS, and HSV color spaces. After the saturation degrees of each pixel in an image are adjusted, the methods and apparatuses of this invention can also further generate a statistical result, based on the adjusted saturation degrees, as the saturation characteristic of the image.

The advantage and spirit of the invention may be understood by the following recitations together with the appended drawings.

### BRIEF DESCRIPTION OF THE APPENDED DRAWINGS

FIG. 1 is the flowchart of the image adjusting method in the first preferred embodiment according to this invention.

FIG. 2 is the flowchart of the image adjusting method in the second preferred embodiment according to this invention.

FIG. 3 is the block diagram of the image adjusting apparatus in the third preferred embodiment according to this invention.

FIG. 4 is the block diagram of the image adjusting apparatus in the fourth preferred embodiment according to this invention.

FIG. 5 is the block diagram of the image adjusting apparatus in the fifth preferred embodiment according to this invention.

### DETAILED DESCRIPTION OF THE INVENTION

The present invention provides methods and apparatuses for adjusting the saturation degree of a target pixel. In the present invention, the target pixel is hypothetically set to be represented as a brightness factor and a set of color factors in a first color space. The brightness factor and the set of color factors may be transformed from an RGB color space. The first color space can be one of the color spaces with separate brightness and color factors, such as YCbCr, YUV, and Lab color spaces.

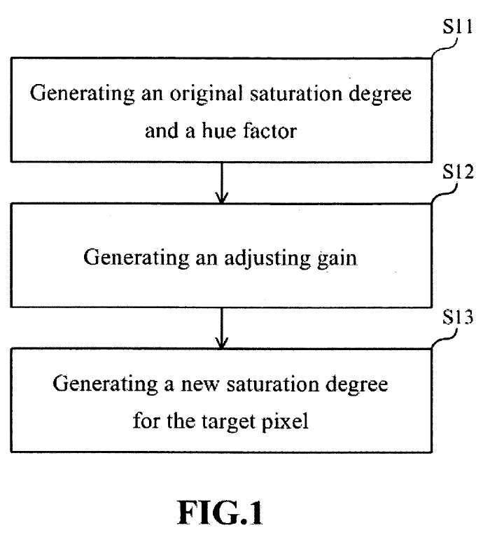

The first preferred embodiment, according to this invention, is an image adjusting method. Please refer to FIG. 1, which illustrates the flowchart of this preferred embodiment.

First, in step S11, an original saturation degree (S) and a hue factor (H) are generated according to the set of color factors. Taking Lab color space as an example, all the colors in Lab color space respectively has a brightness factor (L), a first color factor (a), and a second color factor (b). Thus, in step S11, the original saturation degree (S) can be generated by calculating (a²+b²)^{0.5}, and the hue factor (H) can be generated by calculating tan⁻¹(b/a).

In step S12, an adjusting gain (G) is generated selectively according to the brightness factor (L), the hue factor (H), and the original saturation degree (S). In actual applications, the adjusting gain (G) can be selected from a look-up table selectively according to the brightness factor (L), the hue factor (H), and the original saturation degree (S). According to this invention, when adjusting saturation degrees, users can decide which factors should be taken into consideration based on their own needs. That is to say, the adjusting gain (G) can be relative to all the factors: brightness factor (L), the hue factor (H), and the original saturation degree (S); the adjusting gain (G) can also be relative to only one or two factors among the three factors.

After the adjusting gain (G) is found, in step S13, the original saturation degree (S) is multiplied by the adjusting gain (G) to generate a new saturation degree (S_{N}) for the target pixel.

In some conditions, the first color space may be HIS or HSV color spaces. In HIS or HSV color spaces, the target pixel is represented as an original saturation degree (S), a hue factor (H), and a brightness factor (L). In these conditions, step S11 above can be omitted. The method according to this invention can directly generate the adjusting gain (G) based on the original saturation degree (S), the hue factor (H), and the brightness factor (L), and then the original saturation degree (S) is multiplied by the adjusting gain (G).

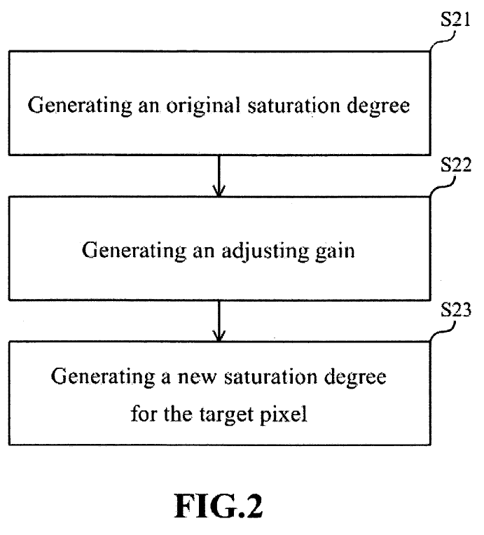

The second preferred embodiment, according to this invention, is also an image adjusting method. Please refer to FIG. 2, which illustrates the flowchart of this preferred embodiment. One main difference between the first and second preferred embodiments is that the hue factor (H) is not taken into consideration in the second preferred embodiment. Accordingly, in step S21, only an original saturation degree (S) is generated according to the set of color factors. The hue factor (H) is not generated in this embodiment. In step S22, an adjusting gain (G) is generated selectively according to the brightness factor (L) and the original saturation degree (S). In this embodiment, the adjusting gain (G) can be relative to both the brightness factor (L) and the original saturation degree (S); the adjusting gain (G) can also be relative to only one among the two factors. Step S23 is the same as step S13. In step S23, the original saturation degree (S) is multiplied by the adjusting gain (G) to generate a new saturation degree (S_{N}) for the target pixel.

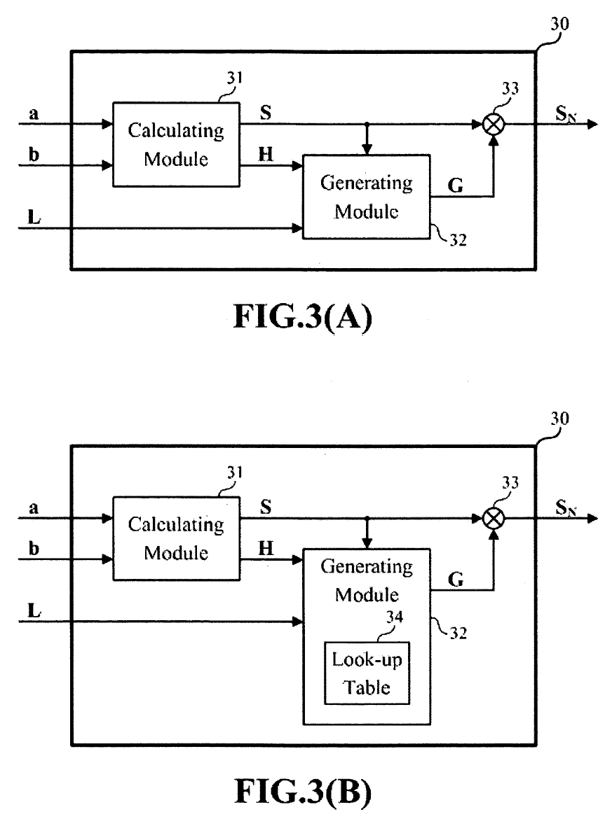

The third preferred embodiment, according to this invention, is an image adjusting apparatus. Please refer to FIG. 3(A), which illustrates the block diagram of this preferred embodiment. The image adjusting apparatus 30 includes a calculating module 31, a generating module 32, and a multiplying module 33. The calculating module 31 is used for generating an original saturation degree (S) and a hue factor (H) according to the set of color factors. In the FIG. 3(A), the set of color factors includes a first color factor (a) and a second color factor (b), and the brightness factor is represented as L. The generating module 32 is used for generating an adjusting gain (G) selectively according to the brightness factor (L), the hue factor (H), and the original saturation degree (S). The multiplying module 33 is used for multiplying the original saturation degree (S) by the adjusting gain (G) to generate a new saturation degree (S_{N}) for the target pixel. In actual applications, as shown in FIG. 3(B), the generating module 32 can further include a look-up table 34, and the adjusting gain (G) is selected from the look-up table 34 selectively according to the brightness factor (L), the hue factor (H), and the original saturation degree (S).

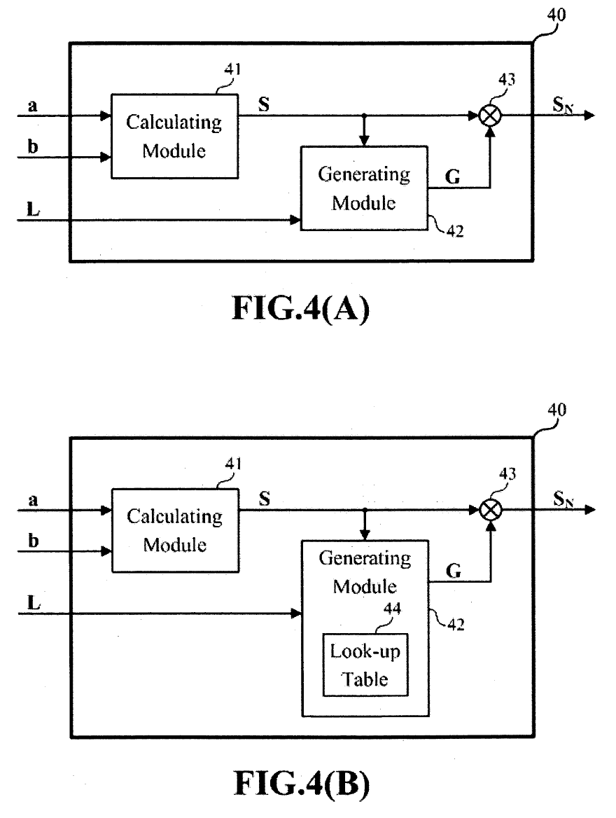

The fourth preferred embodiment, according to this invention, is also an image adjusting apparatus. Please refer to FIG. 4(A), which illustrates the block diagram of this preferred embodiment. The image adjusting apparatus 40 includes a calculating module 41, a generating module 42, and a multiplying module 43. This embodiment is corresponding to the aforementioned second preferred embodiment. As shown in FIG. 4(A), the calculating module 41 is used for generating only an original saturation degree (S). The generating module 42 is used for generating an adjusting gain (G) selectively according to the brightness factor (L) and the original saturation degree (S). The multiplying module 43 is used for multiplying the original saturation degree (S) by the adjusting gain (G) to generate a new saturation degree (S_{N}) for the target pixel. In actual applications, as shown in FIG. 4(B), the generating module 42 can further include a look-up table 44, and the adjusting gain (G) is selected from the look-up table 44 selectively according to the brightness factor (L) and the original saturation degree (S).

In actual applications, after the saturation degrees of each pixel in an image are adjusted, the methods and apparatuses of this invention can also further generate a statistical result, based on the adjusted saturation degrees, to be the saturation characteristic of the image.

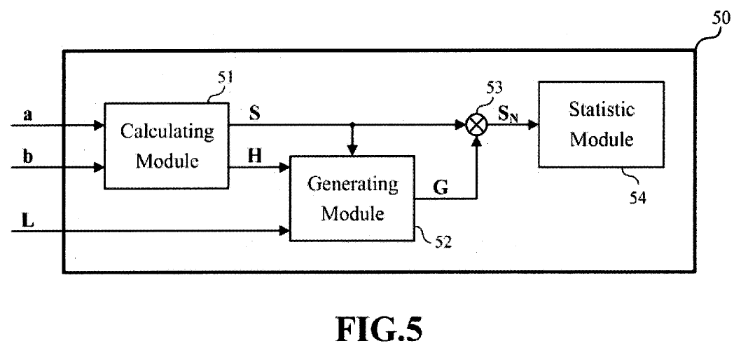

The fifth preferred embodiment, according to this invention, is an apparatus for generating a saturation characteristic of an image. The image includes M pixels, wherein M is a positive integer. Each of the M pixels respectively has a brightness factor (L) and a set of color factors. Please refer to FIG. 5, which illustrates the block diagram of this preferred embodiment. Compared with the image adjusting apparatus 30 in FIG. 3(A), the saturation characteristic generating apparatus further includes a statistic module 54. According to the respective set of color factors of the M pixels, the calculating module 51 generates an original saturation degree (S) and a hue factor (H) for each of the M pixels, respectively. Then, selectively according to the respective brightness factor (L), the respective hue factor (H), and the respective original saturation degree (S), the generating module 52 generates an adjusting gain (G) for each of the M pixels, respectively. The multiplying module 53 is used for multiplying the respective original saturation degree (S) by the respective adjusting gain (G) to generate a new saturation degree (S_{N}) for each of the M pixels, respectively. According to the new saturation degrees (S_{N}) of the M pixels, the statistic module 54 generates a statistical result as the saturation characteristic of the image.

Although Lab color space is taken as the example in the embodiments above, the methods and apparatuses, according to this invention, can be applied in every color spaces with separate brightness and color factors, such as YCbCr, YUV, Lab, HIS, and HSV color spaces. The methods and apparatuses, according to this invention, adjust the saturation degree of an image based on the original saturation degree, hue, and brightness of the image simultaneously, instead of merely based on the original saturation degree. Therefore, the present invention can provide adjusted images more conforming to visual characteristics of human beings.

With the above example and explanation, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for adjusting a saturation degree of a target pixel, in a first color space, the target pixel being represented as a brightness factor and a set of color factors, the method comprising:
(a) according to the set of color factors, generating an original saturation degree and a hue factor;
(b) selectively according to the brightness factor, the hue factor, and the original saturation degree, generating an adjusting gain; and
(c) multiplying the original saturation degree by the adjusting gain to generate a new saturation degree for the target pixel.

2. The method of claim 1, wherein the first color space is a YUV color space, a YIQ color space, a YCbCr color space, or a CIELab color space.

3. The method of claim 1, wherein the brightness factor and the set of color factors are transformed from an RGB color space.

4. The method of claim 1, wherein the set of color factors comprises a first color factor (a) and a second color factor (b); in the step (a), the original saturation degree is equal to (a²+b²)^{0.5}, and the hue factor is equal to tan⁻¹(b/a).

5. The method of claim 1, wherein in the step (b), the adjusting gain is selected from a look-up table selectively according to the brightness factor, the hue factor, and the original saturation degree.

6. A method for adjusting a saturation degree of a target pixel, in a first color space, the target pixel being represented as a brightness factor and a set of color factors, the method comprising:
(a) according to the set of color factors, generating an original saturation degree;
(b) selectively according to the brightness factor and the original saturation degree, generating an adjusting gain; and
(c) multiplying the original saturation degree by the adjusting gain to generate a new saturation degree for the target pixel.

7. The method of claim 6, wherein the first color space is a YUV color space, a YIQ color space, a YCbCr color space, or a CIELab color space.

8. The method of claim 6, wherein the brightness factor and the set of color factors are transformed from an RGB color space.

9. The method of claim 6, wherein the set of color factors comprises a first color factor (a) and a second color factor (b), and the original saturation degree is equal to (a²+b²)^{0.5} in the step (a).

10. The method of claim 6, wherein in the step (b), the adjusting gain is selected from a look-up table selectively according to the brightness factor and the original saturation degree.

11. A method for generating a saturation characteristic of an image, the image comprising M pixels, M being a positive integer, each of the M pixels respectively having a brightness factor and a set of color factors, the method comprising:
(a) according to the respective set of color factors, generating an original saturation degree and a hue factor for each of the M pixels, respectively;
(b) selectively according to the respective brightness factor, the respective hue factor, and the respective original saturation degree, generating an adjusting gain for each of the M pixels, respectively;
(c) multiplying the respective original saturation degree by the respective adjusting gain to generate a new saturation degree for each of the M pixels, respectively; and
(d) according to the new saturation degrees of the M pixels, generating a statistical result as the saturation characteristic of the image.

12. An apparatus for adjusting a saturation degree of a target pixel, in a first color space, the target pixel being represented as a brightness factor and a set of color factors, the apparatus comprising:
a calculating module for generating an original saturation degree and a hue factor according to the set of color factors;
a generating module for generating an adjusting gain selectively according to the brightness factor, the hue factor, and the original saturation degree; and
a multiplying module for multiplying the original saturation degree by the adjusting gain to generate a new saturation degree for the target pixel.

13. The apparatus of claim 12, wherein the first color space is a YUV color space, a YIQ color space, a YCbCr color space, or a CIELab color space.

14. The apparatus of claim 12, wherein the brightness factor and the set of color factors are transformed from an RGB color space.

15. The apparatus of claim 12, wherein the set of color factors comprises a first color factor (a) and a second color factor (b), and the calculating module generates the original saturation degree by calculating (a²+b²)^{0.5} and generates the hue factor by calculating tan⁻¹(b/a).

16. The apparatus of claim 12, wherein the generating module comprises a look-up table and the adjusting gain is selected from the look-up table selectively according to the brightness factor, the hue factor, and the original saturation degree.

17. An apparatus for adjusting a saturation degree of a target pixel, in a first color space, the target pixel being represented as a brightness factor and a set of color factors, the apparatus comprising:
a calculating module for generating an original saturation degree according to the set of color factors;
a generating module for generating an adjusting gain selectively according to the brightness factor and the original saturation degree; and
a multiplying module for multiplying the original saturation degree by the adjusting gain to generate a new saturation degree for the target pixel.

18. The apparatus of claim 17, wherein the first color space is a YUV color space, a YIQ color space, a YCbCr color space, or a CIELab color space.

19. The apparatus of claim 17, wherein the brightness factor and the set of color factors are transformed from an RGB color space.

20. The apparatus of claim 17, wherein the set of color factors comprises a first color factor (a) and a second color factor (b), and the calculating module generates the original saturation degree by calculating (a²+b²)^{0.5} and generates the hue factor by calculating tan⁻¹(b/a).

21. The apparatus of claim 17, wherein the generating module comprises a look-up table and the adjusting gain is selected from the look-up table selectively according to the brightness factor, the hue factor, and the original saturation degree.

22. An apparatus for generating a saturation characteristic of an image, the image comprising M pixels, M being a positive integer, each of the M pixels respectively having a brightness factor and a set of color factors, the apparatus comprising:
a calculating module, according to the respective set of color factors, the calculating module generating an original saturation degree and a hue factor for each of the M pixels, respectively;
a generating module, selectively according to the respective brightness factor, the respective hue factor, and the respective original saturation degree, the generating module generating an adjusting gain for each of the M pixels, respectively;
a multiplying module for multiplying the respective original saturation degree by the respective adjusting gain to generate a new saturation degree for each of the M pixels, respectively; and
a statistic module, according to the new saturation degrees of the M pixels, the statistic module generating a statistical result as the saturation characteristic of the image.

23. A method for adjusting a saturation degree of a target pixel, in a first color space, the target pixel being represented as an original saturation degree, a hue factor, and a brightness factor, the method comprising:
(a) selectively according to the original saturation degree, the hue factor, and the brightness factor, generating an adjusting gain; and
(b) multiplying the original saturation degree by the adjusting gain to generate a new saturation degree for the target pixel.

24. The method of claim 23, wherein the first color space is a HSV color space or a HSI color space.

25. The method of claim 23, wherein the original saturation degree, the hue factor, and the brightness factor are transformed from an RGB color space.

26. The method of claim 23, wherein in the step (a), the adjusting gain is selected from a look-up table selectively according to the original saturation degree, the hue factor, and the brightness factor.
